(19) United States
(12) Patent Application Publication
(10) Pub. No.: US 2026/0138217 A1
(43) Pub. Date: May 21, 2026

(54) FLEXIBLE COPPER FILM USING BIODEGRADABLE BINDER AND METHOD OF FORMING SAME

(71) Applicant: Hojeonable Inc., Daejeon (KR)

(72) Inventors: Beyong Hwan RYU, Daejeon (KR); Yun Soo PARK, Hwaseong-si (KR); Da Hye CHOI, Sejong-si (KR); Jong Tae MOON, Gyeryong-si (KR)

(73) Assignee: Hojeonable Inc., Daejeon (KR)

(21) Appl. No.: 19/381,541

(22) Filed: Nov. 6, 2025

(30) Foreign Application Priority Data
Nov. 21, 2024 (KR) 10-2024-0166816

(51) Int. Cl. B23K 35/02; B23K 35/30; C08K 3/08; C08K 5/09; C08L 67/02; C08L 67/04; C08L 69/00

(52) U.S. Cl. CPC B23K 35/025; B23K 35/302; C08K 3/08; C08K 5/09; C08L 67/02; C08L 67/04; C08L 69/00; C08K 2003/085; C08K 2201/001; C08L 2201/56; C08L 2203/16

(57) ABSTRACT

Proposed are a copper film paste composition including copper particles, a biodegradable resin, a resin for structural reinforcement, a solvent, and an additive. In addition, a flexible copper film formed therefrom is proposed. The flexible copper film is capable of forming a uniform and smooth film, has significantly high bonding strength, and can minimize the environmental impact of waste disposal by using the biodegradable resin.

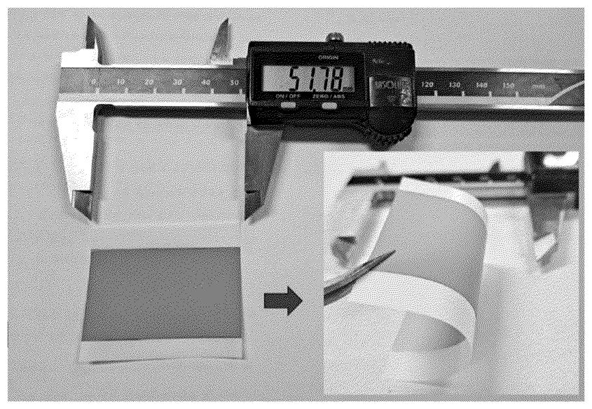

### CROSS REFERENCE TO RELATED APPLICATION

The present application claims priority to Korean Patent Application No. 10-2024-0166816, filed on Nov. 21, 2024, the entire contents of which are incorporated herein by reference for all purposes.

### BACKGROUND

### 1. Technical Field

The present disclosure relates to a flexible copper (Cu) film using a biodegradable binder and a method of forming the same.

### 2. Description of the Related Art

Recently, with the growing demand for weight reduction and efficiency improvement in the electronic device, automobile, and energy industries, various electrically conductive film materials have been actively developed. Although silver (Ag)-based sintering films mainly serve as currently available electrically conductive films, the use of expensive materials results in poor cost-effectiveness. Accordingly, there is a need to develop materials to replace this material.

Copper (Cu) materials are being widely used as wiring and electrode materials in electronic products due to having high conductivity and relatively low cost. However, copper materials are prone to oxidation, and maintaining flexibility and durability is challenging when forming such copper materials into film forms. Therefore, research is required to improve the oxidation resistance of copper films while simultaneously improving sintering properties.

Existing copper film materials are typically formed into films by mixing with resins for structural reinforcement and various additives to obtain strength and flexibility. For example, various types of resins for structural reinforcement, including polycarbonate (PC), polymethyl methacrylate (PMMA), and polybutylene terephthalate (PBT), are used for film formation, and biodegradable resins, such as polycaprolactone (PCL) and polybutylene adipate-co-terephthalate (PBAT), are being developed. However, copper films based on such resins face difficulties in practical applications mainly due to low sintering strength and limited physical properties.

Furthermore, in film formation processes, attempts have been made to inhibit oxidation of copper particles by adding reducing agents to film compositions for oxidation prevention, and to enhance film uniformity by improving particle dispersibility using surfactants.

### DOCUMENTS OF RELATED ART

### Patent Documents

(Patent Document 1) Korean Patent No. 10-2223079 (Feb. 25, 2021)
(Patent Document 2) Korean Patent No. 10-2183242 (Nov. 19, 2020)

### Non-Patent Documents

(Non-Patent Document 1) Jiao Jian, Zeng Xiangbin, Huang Xianbo, AN OVERVIEW ON SYNTHESIS, PROPERTIES AND APPLICATIONS OF POLY(BUTYLENE-ADIPATE-CO-TEREPHTHALATE)-PBAT, Advanced Industrial and Engineering Polymer Research, 2020, 3, 19-26.
(Non-Patent Document 2) Gerrit A. Luinstra and Endres Borchardt, MATERIAL PROPERTIES OF POLY(PROPYLENE CARBONATES), Advances in Polymer Science, 2012, volume 245, 29-48.

### SUMMARY

To address the aforementioned issues, the present disclosure aims to provide a flexible Cu film using a biodegradable binder and a method of forming the same.

The present disclosure provides a copper film paste composition including: copper particles; a biodegradable resin; a resin for structural reinforcement; a solvent; a reducing agent; a surfactant; and a film-forming additive.

The biodegradable resin may include one or more selected from the group consisting of polycaprolactone (PCL), polybutylene adipate-co-terephthalate (PBAT), polybutylene succinate (PBS), polybutylene succinate adipate terephthalate (PBSAT), and polymethyl adipate terephthalate (PMAT).

The biodegradable resin may have a glass transition temperature (T_{g}) of room temperature or lower.

The resin for structural reinforcement may include one or more selected from the group consisting of polycarbonate (PC), polypropylene carbonate (PPC), polymethyl methacrylate (PMMA), polyethylene terephthalate (PET), polyamide (PA), polybutylene terephthalate (PBT), polysulfone (PSU), and polyphenylene sulfide (PPS).

The solvent may include one or more selected from the group consisting of dimethyl succinate, dimethyl adipate, dimethyl carbonate (DMC), diethyl carbonate, dimethyl glutarate, ethylene glycol diacetate, propylene carbonate, ethylene carbonate, 2-methoxyethanol carbonate, γ-butyrolactone (GBL), dimethylformamide (DMF), N-methylpyrrolidone (NMP), 2-pyrrolidone, and octanediol.

The reducing agent may include one or more selected from the group consisting of propionic acid, caproic acid, caprylic acid, glutaric acid, glutamic acid, citric acid, succinic acid, adipic acid, phthalic acid, fumaric acid, malonic acid, stearic acid, maleic acid, mercaptopropionic acid, and γ-aminobutyric acid.

The surfactant may include one or more selected from the group consisting of triethanolamine (TEA), diethanolamine, monoethanolamine, cocamide diethanolamine (cocamide DEA), TEA-lauryl sulfate, cocamidopropyl betaine, and lauryl glucoside.

The film-forming additive may include one or more selected from the group consisting of ethyl cellulose (EC), hydroxypropyl methylcellulose, hydroxyethyl cellulose, methylcellulose, polyvinyl alcohol, polyurethane, polyacrylic acid, polylactic acid, and acetyl cellulose.

In addition, the present disclosure provides a flexible copper film formed from the copper film paste composition.

The flexible copper film may have a bonding strength of 15 MPa or higher.

The present disclosure proposes a copper film paste composition including a biodegradable resin, various resins for structural reinforcement, a solvent, a reducing agent, a surfactant, and a film-forming additive. Through this composition, a copper film exhibiting high conductivity and excellent flexibility by improving mechanical stability and bonding strength, the film being capable of demonstrating good performance even in high-temperature and high-humidity environments, can be formed.

### BRIEF DESCRIPTION OF THE DRAWING

The FIGURE is a photograph showing an example of a flexible Cu film according to the present disclosure.

### DETAILED DESCRIPTION

Hereinafter, a flexible Cu film using a biodegradable binder and a method of forming the same, according to the present disclosure, are to be described in detail. The accompanying drawing is provided as one example to fully convey the idea of the present disclosure to those skilled in the art. Accordingly, the present disclosure is not limited to the accompanying drawing, and may be embodied in other forms. The accompanying drawing may be exaggerated to clarify the idea of the present disclosure. In this case, technical and scientific terms used in the present disclosure have the same meaning as commonly understood by those skilled in the art to which the present disclosure pertains, unless otherwise defined. Furthermore, in the following description and accompanying drawing, it is to be noted that descriptions of known functions and configurations that may unnecessarily obscure the gist of the present disclosure are to be omitted.

The present disclosure provides a copper film paste composition including: copper particles; a biodegradable resin; a resin for structural reinforcement; a solvent; and an additive. In this case, the copper film paste composition may include 4 to 16 parts by weight of the biodegradable resin and to 14 parts by weight of the resin for structural reinforcement, with respect to 100 parts by weight of the copper particles.

As described above, the copper particles may account for 65 to 87 parts by weight of 100 parts by weight of the copper film paste composition. When the content of the copper particles is higher than the above numerical range, the viscosity of the resulting paste may be extremely high. On the contrary, when the content of the copper particles is lower than the above numerical range, the viscosity is low, meaning that the paste is extremely watery, and there may be a problem in that films for sintering are not readily formed.

The copper particles may have an average particle diameter in the range of 0.05 to 5.0 μm. The particle size distribution in nanometer and micrometer units has a significant impact on the density and conductivity of a film, and is advantageous for forming a uniform conductive path. While nanometer-scale copper particles can lower the temperature required for sintering, thus reducing the energy necessary for the sintering process, micrometer-scale copper particles can improve the mechanical strength of a film, which is advantageous. In this case, the bonding strength of a copper film can be maximized when a bimodal distribution of the average particle diameter is formed, preferably, by mixing nanometer-scale copper particles having an average particle diameter in the range of 50 to 150 nm with micrometer-scale copper particles having an average particle diameter in the range of 1 to 5 μm. Here, the mixing ratio of the nanometer-scale copper particles to the micrometer-scale copper particles may be in the range of 1:0.5 to 1.5. By preparing the composition using these copper particles satisfying the numerical ranges described above, a copper film, obtained by sintering the composition, may be formed to have a bonding strength of at least 10 MPa, preferably 15 MPa or higher.

The copper particles may have a spherical, flake-like, or dendritic shape. The spherical particles enable the film surface to be smoothly formed, and the flake-like particles can achieve a conductivity improvement effect by increasing the film density and the number of conductive paths. Furthermore, the dendritic structure has an increased surface area and is thus advantageous for enhancing bonding strength and rigidity.

The copper particles, as the main conductive component of the film, may have a surface free of oxide film. Because copper particles are prone to oxidation in air, conductivity may deteriorate, and oxide film may weaken the interparticle binding strength during sintering. Thus, a process in which oxide film is removed from the surface of the copper particles using the aforementioned reducing agent or a separate oxide film remover is preferably performed.

The solvent, the reducing agent, and the surfactant are vaporized or decomposed when exposed to a temperature range of 200° C. to 300° C. Accordingly, the use of such materials prevents organic residues from remaining during bonding, which enables the bonding strength of a copper film to remain high.

The biodegradable resin, a polymer material naturally decomposed by microorganisms in the environment, has been attracting attention as part of sustainable material development and environmental pollution reduction. In addition, the biodegradable resin used in the present disclosure, which is to improve the flexibility and environmental stability of the film, has a low glass transition temperature (T_{g}) of room temperature or lower, and thus may exist in a rubber phase under normal use conditions (room temperature). Preferably, the biodegradable resin has a T_{g} in the range of −70° C. to −15° C., which is significantly low. This enables the film to exhibit excellent flexibility and environmental stability at room temperature.

In addition, as described above, when capping the copper particles with a polymer, the binding strength with the biodegradable resin is further maximized, which may further enhance the flexibility, durability, weather resistance, and tensile strength of the film.

More specifically, the biodegradable resin may include one or more selected from the group consisting of polycaprolactone (PCL), polybutylene adipate-co-terephthalate (PBAT), polybutylene succinate (PBS), polybutylene succinate adipate terephthalate (PBSAT), and polymethyl adipate terephthalate (PMAT).

In particular, PCL, which has a T_{g} of about −60° C. and a melting point of about 60° C., exhibits significantly high flexibility by maintaining a rubber phase at room temperature. As a result, not only is the durability of the copper film against bending or impact excellent, but also the mechanical properties thereof are excellent even at low temperatures. PBAT, which has a Ty of about −30° C. and a melting point of about 115° C., exhibits significantly high elongation, as well as excellent durability and flexibility. PBS, which has a T_{g} of about −45° C. and a melting point of about 115° C., exhibits excellent heat resistance and wear resistance, so the film may have improved physical stability. In particular, because the difference between T_{g} and the melting point is considerable, the mechanical properties can remain stable even in environments with significant temperature variations. PBSAT, which has a T_{g} of about −20° C. and a melting point of about 125° C., exhibits significantly high flexibility and tensile strength, and is thus advantageous for film formation into complex shapes. PMAT exhibits not only excellent flexibility at room temperature due to having a low T_{g} of about −15° C., but also high durability against external impact, thereby enabling the formation of a film capable of withstanding repeated physical deformation. As described above, the biodegradable resin has a significantly low T_{g}, and thus can improve the flexibility of the film. However, when preparing the composition using the biodegradable resin alone, formability is significantly poor because the biodegradable resin exists in a rubber phase at room temperature, which makes film formation challenging.

The resin for structural reinforcement, which is to impart formability, may be applied taking into consideration viscosity, flexibility, mechanical strength, thermal stability, bonding strength, and the like. For example, the resin for structural reinforcement may include one or more selected from the group consisting of polycarbonate (PC), polypropylene carbonate (PPC), polymethyl methacrylate (PMMA), polyethylene terephthalate (PET), polyamide (PA), polybutylene terephthalate (PBT), polysulfone (PSU), and polyphenylene sulfide (PPS).

PC and PET can impart appropriate viscosity to the composition, thereby contributing to the enhanced uniformity and surface quality of the film during the formation process. In addition, PA and PBT exhibit high flexibility, thereby preventing the film from tearing or cracking during bending or extrusion, enabling the film to be stably formed, and having high durability even against physical impact or deformation that may occur during the formation process. PPC, which has a low T_{g} in the range of about 15° C. to 25° C., exhibits excellent flexibility and maintains a rubber phase at room temperature. In addition, PPC has biodegradable properties and is thus characterized by being easily mixed with the aforementioned biodegradable resin, as well as further reducing concerns regarding environmental pollution. PSU and PPS exhibit significantly high mechanical strength, thereby enhancing the durability of the film and enabling the formation of films with strong resistance to deformation and wear.

In particular, PC and PSU exhibit significantly high thermal stability, such that the physical properties thereof are prevented from deformation even when formed at high temperatures, and deformation and expansion caused by heat are minimal even after formation. Thus, PC, which exhibits high viscosity, strength, and thermal stability, is preferably used. However, to further reduce concerns regarding environmental pollution, PPC can be used, while PA or PBT can be used to further improve flexibility.

As described above, the biodegradable resin and the resin for structural reinforcement are in a complementary relationship. Accordingly, optimizing the ratio between the two resins is necessary for optimization of flexibility, mechanical strength, and film formation. For example, the resin for structural reinforcement is preferably mixed in a ratio in the range of 20 to 80 parts by weight, with respect to 100 parts by weight of the biodegradable resin. Within such a numerical range, formation into a film is facilitated, and the film formed in such a manner may exhibit flexibility, excellent mechanical strength, and excellent bonding strength, especially 15 MPa or higher.

The solvent not only promotes uniform mixing of the biodegradable resin with the resin for structural reinforcement to obtain stable dispersion within the composition, but also strengthens the interaction between the copper particles and the additives, thereby contributing to optimizing the physical properties of the paste composition. Furthermore, the solvent imparts appropriate viscosity during the film formation process, enabling the formation of a uniform and smooth film. The composition may be prepared such that the biodegradable resin and the resin for structural reinforcement are mixed in a combined amount in the range of 5 to 15 parts by weight, with respect to 100 parts by weight of the solvent.

Materials that may serve as the solvent may be selected according to characteristics, such as control of polarity, volatility, and viscosity, ease of removal, environmental friendliness, and chemical resistance. The solvent may include one or more selected from the group consisting of dimethyl succinate, dimethyl adipate, dimethyl carbonate (DMC), diethyl carbonate, dimethyl glutarate, ethylene glycol diacetate, propylene carbonate, ethylene carbonate, 2-methoxyethanol carbonate, γ-butyrolactone (GBL), dimethylformamide (DMF), N-methylpyrrolidone (NMP), 2-pyrrolidone, and octanediol.

The solvent, as a polar solvent, may be selected from the group consisting of propylene carbonate, GBL, DMF, NMP, 2-pyrrolidone, and ethylene carbonate. Such a solvent has strong polarity while being easily mixed with non-polar materials, thereby improving the solubility of the biodegradable resin and the resin for structural reinforcement while promoting uniform mixing of the copper particles, the additives, and the like.

The solvent, as a highly volatile solvent, may be selected from the group consisting of DMC, diethyl carbonate, dimethyl succinate, dimethyl adipate, and dimethyl glutarate. Such a solvent is easily evaporated during the heat treatment process due to having high volatility and a low boiling point, and may thus not remain on the film.

The solvent, as a high-viscosity solvent capable of increasing viscosity, may be selected from the group consisting of GBL, propylene carbonate, ethylene carbonate, NMP, and 2-pyrrolidone. Such a solvent exhibits high viscosity, enabling the viscosity and formability of the paste composition to be controlled, and may contribute to the uniform distribution of the copper particles, the biodegradable resin, the resin for structural reinforcement, and the like during film formation.

The solvent, as an environmentally friendly biodegradable solvent, may be selected from the group consisting of dimethyl succinate, dimethyl adipate, DMC, and ethylene glycol diacetate. Such a solvent is capable of biodegradation or natural decomposition, thereby minimizing the impact thereof on the environment.

The solvent, as a chemical-resistant solvent, may be selected from the group consisting of GBL, propylene carbonate, and ethylene carbonate. Such a solvent can be mixed stably with various types of additives due to having significantly high chemical resistance, and is characterized by not being readily decomposed even at high temperatures.

Furthermore, the solvent, as a composite solvent capable of performing various roles such as solubility control, viscosity control, or volatility control, may be selected from the group consisting of DMF, NMP, 2-pyrrolidone, and GBL. In particular, film formation may be facilitated when using DMF and NMP.

Examples of the additives may include reducing agents, surfactants, and film-forming additives.

As described above, the copper film paste composition, according to the present disclosure, may include a reducing agent to remove oxide film from the copper particles while preventing further oxidation. The reducing agent may include one or more selected from the group consisting of propionic acid, caproic acid, caprylic acid, glutaric acid, glutamic acid, citric acid, succinic acid, adipic acid, phthalic acid, fumaric acid, malonic acid, stearic acid, maleic acid, mercaptopropionic acid, and γ-aminobutyric acid.

In addition, the reducing agent can not only prevent oxidation of the copper particles that may occur due to exposure to oxygen during the film formation process through sintering, but also prevent oxidation of the copper film paste composition during long-term storage or preservation, and is thus further advantageous for maintaining quality. As for such a reducing agent, commonly used acidic materials may be available. However, to achieve the purpose of preventing environmental pollution, as described above, the reducing agent is preferably selected from the above organic acid group and used. Preferably, a low-molecular-weight organic acid that is highly active and volatile is used. For example, one or more selected from propionic acid, caproic acid, and caprylic acid are preferably used. Furthermore, the functionality described above can be maximized when including 0.5 to 1.5 parts by weight of the reducing agent with respect to 100 parts by weight of the copper particles.

An oxide film remover that can serve as another material for removing oxide film from the copper particles may form a copper salt by reacting with copper oxide film (CuO). The oxide film remover is not particularly limited in type as long as it is an ammonium salt, and may specifically be an aqueous solution containing ammonium salts, such as NH₄Cl, NH₄NO₃, and (NH₄)₂SO₄. Using the oxide film remover by mixing in an aqueous ammonia solution facilitates the removal of copper oxide film and, therefore, is preferable.

The oxide film remover and the aqueous ammonia solution may be mixed in a weight ratio in the range of 1:0.5 to 2. When the amount of the oxide film remover added is smaller than that of the aqueous ammonia solution, the removal of the oxide film may not be complete, resulting in deterioration of physical properties such as bonding strength and flexibility during sintering. On the contrary, when the amount of the oxide film remover added is excessive, copper may be excessively dissolved, leading to increased consumption of the copper nanoparticles.

In addition, the copper particles may have a surface capped with a polymer. Polymer capping may be performed by, after removing the existing oxide film from the surface of the copper particles, as described above, bonding a polymerization initiator to the surface of the copper particles and polymerizing a polymer monomer on the surface of the copper nanoparticles to which the polymerization initiator is bonded.

The polymer with which the copper particles are capped may be one selected the any from group consisting of polyvinylpyrrolidone, polyethylene oxide, and the like, a mixture of two or more of the foregoing, or a copolymer thereof. In this case, 1 to 5 parts by weight of the polymer may be included with respect to 100 parts by weight of the copper particles.

Such a polymer may be bonded chemically to the surface of the copper particles and may perform capping through polymerization by further adding a material that may serve as the initiator of the polymer to the monomer. For example, a disulfide-based initiator, such as [S—CH₂CH₂OCOC(CH₃)₂Br]₂ or [S—(CH₂)₁₁OCOC(CH₃)₂Br]₂ containing a thiol group, is preferably used. Through the use of such an initiator, the monomer can be polymerized, thereby performing surface capping in which the polymer is bonded chemically to the surface of the copper nanoparticles.

In this case, the density of the polymer to be polymerized may be controlled according to the treatment time of the initiator. As the treatment time increases, the density of the polymer to be polymerized may increase. The monomer may be selected from monomers capable of forming the above polymer, and vinylpyrrolidone is preferably used.

The surfactant improves the compatibility between the copper particles, the biodegradable resin, the resin for structural reinforcement, and other additives, and facilitates particle dispersion, thereby enhancing the stability and performance of the composition.

The surfactant may include one or more selected from the group consisting of triethanolamine (TEA), diethanolamine, monoethanolamine, cocamide diethanolamine (cocamide DEA), TEA-lauryl sulfate, cocamidopropyl betaine, and lauryl glucoside.

The film-forming additive further improves the formability of the composition and serves to form a film having uniform thickness and strength. In addition, the film-forming additive can enhance the flexibility and strength of the film, thereby reducing deformation even under repeated bending or impact. The film-forming additive may include one or more selected from the group consisting of ethyl cellulose (EC), hydroxypropyl methylcellulose, hydroxyethyl cellulose, methylcellulose, polyvinyl alcohol, polyurethane, polyacrylic acid, polylactic acid, and acetyl cellulose. In particular, EC, a known additive that can impart excellent film formation ability and mechanical strength, can control hydrophilicity and hydrophobicity, demonstrating high versatility, and thus is preferably used.

In addition, the present disclosure provides a flexible copper film formed from the copper film paste composition.

The copper film paste composition may be applied by a bar coating, spin coating, inkjet printing, slot-die coating, spray coating, or dip coating method, and then subjected to heat treatment to form a film. In this case, when applying the copper film paste composition to a thickness in the range of 50 to 150 μm, the bonding strength of the resulting film can be maximized. In addition, after the copper film paste composition is applied, a solvent evaporation process is preferably performed. During the solvent evaporation process, the applied material can exhibit the physical properties of a film or gel by elimination of the solvent serving as a plasticizer, and may be subjected to heat treatment to form a flexible copper film.

In this case, the aforementioned solvent evaporation process is preferably performed at a temperature in the range of 100° C. to 150° C. for 10 to 180 minutes. The above material group, which is volatile and has a low boiling point, can be easily evaporated under such conditions.

Furthermore, after completion of solvent evaporation, the heat treatment may be performed at a temperature in the range of 200° C. to 400° C. for 1 to 10 minutes. In this case, when performing the heat treatment under a pressure in the range of to 20 MPa, the bonding strength of the flexible copper film can be maximized. However, a portion of the biodegradable resin or the resin for structural reinforcement may undergo thermal decomposition at a temperature of at least 300° C., or 350° C. or higher in some cases. Therefore, the heat treatment is preferably performed at a temperature in the range of 200° C. to 350° C., which is more preferably in the range of 200° C. to 300° C.

By satisfying such conditions, the flexible copper film may have a bonding strength of 15 MPa or higher. In this case, the bonding strength is preferably 25 MPa or higher and more preferably 32.5 MPa or higher. The upper limit of the bonding strength is not particularly limited, but may, for example, be MPa or lower.

Hereinafter, a flexible Cu film using a biodegradable binder and a method of forming the same, according to the present disclosure, are to be described in more detail through examples. However, the following examples are only a reference for describing the present disclosure in detail. The present disclosure is not limited thereto and may be implemented in various forms.

Furthermore, unless otherwise defined, all technical and scientific terms have the same meaning as commonly understood by those skilled in the art to which the present disclosure pertains. The terms used herein are provided only for effectively describing particular examples and are not intended to limit the present disclosure. Furthermore, the unit of additives not particularly described herein may be wt %.

### [Preparation of Copper Film Paste Composition]

A biodegradable resin and a resin for structural reinforcement were dissolved in a solvent such that the combined amount of the two resins was 10 wt %, and then mixed with 29 g of copper powder and 0.3 g of caprylic acid (1 wt % with respect to the copper powder). The resulting mixture was placed in a paste mixer, repeatedly subjected to a stirring process at a speed of 800 rpm for 20 seconds 3 times, and then milled using a 3-roll mill a total of 7 times. As a result, a copper film paste composition was prepared.

### [Formation of Copper Film]

The copper film paste composition was applied to a width of about 10 cm and a thickness of about 80 μm using a bar coater, and then placed in a convection oven in an air atmosphere, followed by solvent evaporation at a temperature of 110° C. for 30 minutes, to form a primary film. At this time, the uniformity of the film, the occurrence of cracks, and the like were visually examined to evaluate formability.

### [Copper Heat Treatment]

A flexible copper film was formed by subjecting the primary film to heat treatment in air at a temperature of 300° C. for 5 minutes under a pressure of 15 MPa. At this time, whether fracture occurred was examined by bending the flexible copper film, thereby evaluating the flexibility of each film.

### Comparative Examples 1 to 3 and Examples 1 to 7

Flexible copper films were formed by adjusting the composition as shown in Table 1 below. At this time, the formability of each film was determined after the copper film formation step, while the flexibility of each film was determined after the copper heat treatment step. As for PPC, a product having a molecular weight in the range of 10,000 to 200,000 was used.

TABLE 1

| | | Weight ratio of | | | | |
|---|---|---|---|---|---|---|
| | | biodegradable | | | | |
| | Average | resin (PCL) to | | | | |
| | particle | resin for | | | | |
| | diameter | structural | | | | Bonding |
| | of copper | reinforcement | | Film | Film | strength |
| Classification | particles | (PPC) | Solvent | formability | flexibility | [MPa] |
| Comparative | About | 99.9:0.1 | DMF | X | — | — |
| Example 1 | 2 μm | | | | | |
| Comparative | About | 99.5:0.5 | DMF | X | — | — |
| Example 2 | 2 μm | | | | | |
| Comparative | About | 9:1 | DMF | X | — | — |
| Example 3 | 2 μm | | | | | |
| Example 1 | About | 8:2 | DMC | Δ | — | 21.5/32.3/ |
| | 2 μm | | | | | 25.7 |
| Example 2 | About | 7:3 | NMP | ◯ | ◯ | 17.4/22.5/ |
| | 2 μm | | | | | 28.9 |
| Example 3 | About | 7:3 | DMF | ◯ | ◯ | 19.9/20.3/ |
| | 2 μm | | | | | 24.7 |
| Example 4 | About | 7:3 | NMP | ◯ | ◯ | 20.9/24.7/ |
| | 2 μm | | | | | 31.5 |
| Example 5 | About | 6:4 | NMP | ◯ | ◯ | 12.1/28.2/ |
| | 2 μm | | | | | 33.2 |
| Example 6 | About | 6:4 | DMF | ◯ | ◯ | 16.9/19.8/ |
| | 2 μm | | | | | 28.0 |
| Example 7 | About | 6:4 | NMP/DMF | ◯ | ◯ | 26.1/32.5/ |
| | 2 μm | | | | | 27.0 |

From Table 1, in the case of Comparative Examples 1 to 3, in which the weight ratio of the biodegradable resin (PCL) to the resin for structural reinforcement (PPC) is in the range of 99.9:0.1 to 9:1, indicating that the content of the resin for structural reinforcement is significantly low, the film is confirmed to exhibit poor formability.

On the other hand, when the content of the resin for structural reinforcement increased as the weight ratio of the biodegradable resin to the resin for structural reinforcement equaled or exceeded 8:2, the film exhibited improved formability. In particular, when optimizing the weight ratio at 7:3 or 6:4, flexibility and bonding strength were confirmed to be improved overall, and the bonding strength was found to be in the range of 17.4 to 32.5 MPa.

In this case, Examples 2 to 4 and Examples 5 to 7 show changes in bonding strength depending on the solvent used. Overall, film formation was confirmed to be possible when using DMF, and the bonding strength was found to be in the range of about 16.9 to 31.5 MPa, which was considered appropriate. When using NMP, the film exhibited excellent formability and flexibility. In particular, Examples 2, 4, and 5 showed excellent bonding strength. DMC was used in Example 1, and the bonding strength obtained was in the range of 21.5 to 32.3 MPa, which was considered sufficient. However, the film was formed with somewhat poor formability and without flexibility. In the case of Example 7, in which the film was formed by mixing NMP and DMF at a weight ratio of 1:1, the film exhibited not only excellent formability and flexibility, but also excellent bonding strength in the range of 26.1 to 32.5 MPa with the smallest deviation.

### Comparative Examples 4 to 6 and Examples 8 to 11

Flexible copper films were formed by adjusting the composition as shown in Table 2 below. At this time, the formability of each film was determined after the copper film formation step, while the flexibility of each film was determined after the copper heat treatment step.

TABLE 2

| | | Weight ratio of | | | | |
|---|---|---|---|---|---|---|
| | | biodegradable resin | | | | |
| | | (PCL) to resin for | | | | Bonding |
| | Cu | structural | | Film | Film | strength |
| Classification | size | reinforcement (PPC) | Solvent | formability | flexibility | [MPa] |
| Comparative | About | 9:0.1 | NMP | X | — | — |
| Example 4 | 2 μm | | | | | |
| Comparative | About | 9:0.5 | NMP | X | — | — |
| Example 5 | 2 μm | | | | | |
| Comparative | About | 9:1 | NMP | X | — | — |
| Example 6 | 2 μm | | | | | |
| Example 8 | About | 8:2 | NMP | ◯ | ◯ | 20.9/22.0/ |
| | 2 μm | | | | | 26.5 |
| Example 9 | About | 7:3 | NMP/GBL | ◯ | ◯ | 19.6/25.6/ |
| | 2 μm | | | | | 32.3 |
| Example 10 | About | 6:4 | NMP | ◯ | ◯ | 21.2/26.4/ |
| | 2 μm | | | | | 29.6 |
| Example 11 | About | 6:4 | NMP/GBL | ◯ | ◯ | 25.4/28.7/ |
| | 2 μm | | | | | 33.5 |

From Table 2, in the case of Comparative Examples 4 to 6, in which the weight ratio of the biodegradable resin (PCL) to the resin for structural reinforcement (PPC) is in the range of 9:0.1 to 9:1, the film is confirmed to exhibit no formability at all. Furthermore, due to the excessively low content of PPC, it is deemed that the homogeneity and formability of the composition could not be obtained.

In Examples 8 to 11, as the weight ratio of biodegradable resin (PCL) to the resin for structural reinforcement (PPC) was optimized to be in the range of 8:2 to 6:4, the film exhibited significantly improved formability and flexibility. In particular, when the weight ratio was 7:3 or 6:4, optimization of the bonding strength was observed.

When using NMP alone, especially in Examples 8 and 10, the film exhibited excellent formability and flexibility, and the bonding strength was found to be in the range of 20.9 to 29.6 MPa, which was considered high. When mixing NMP and GBL at a weight ratio of 1:1 for use as the solvent, the films of Examples 9 and 11 also exhibited excellent formability and flexibility, and the bonding strength was further improved to the range of 19.6 to 32.3 MPa.

### Example 12

Biodegradable resins, PCL and PBAT, and a resin for structural reinforcement (PPC) were mixed at a weight ratio of 1:1:1 to examine the physical properties of a paste composition and a film.

TABLE 3

| | | Weight ratio of | | | | |
|---|---|---|---|---|---|---|
| | | Biodegradable Resin 1 | | | | |
| | | (PCL), Biodegradable | | | | |
| | | resin 2 (PBAT), and | | | | Bonding |
| | Cu | resin for structural | | Film | Film | strength |
| Classification | size | reinforcement (PPC) | Solvent | formability | flexibility | [MPa] |
| Example 12 | About | 1:1:1 | NMP | ◯ | ◯ | 18.7/26.6/ |
| | 2 μm | | | | | 31.5 |

As shown in Table 3, two types of biodegradable resins and one type of resin for structural reinforcement were mixed. However, when mixed at the same weight ratio, PBAT exhibited higher T_{g} and strength than PCL, so the balance between the mechanical strength and flexibility of the film was deemed to be further improved. In addition, the bonding strength was found to be in the range of 18.7 to 31.5 MPa, which was considered high.

### Example 13

PBAT, serving as a biodegradable resin, and EC, serving as a resin for structural reinforcement (Mw: 40,000 to 60,000), were used to examine the physical properties of a paste composition and a film.

TABLE 4

| | | Weight ratio of | | | | |
|---|---|---|---|---|---|---|
| | | biodegradable resin | | | | |
| | | (PBAT) to resin for | | | | Bonding |
| | Cu | structural | | Film | Film | strength |
| Classification | size | reinforcement (EC) | Solvent | formability | flexibility | [MPa] |
| Example 13 | About | 7:3 | NMP | ◯ | X | 18.7/26.6/ |
| | 2 μm | | | | | 21.5 |

As shown in Table 4, the film was formed with PBAT and EC. As a result, although the film exhibited excellent formability, the flexibility was not clearly observed. In addition, the bonding strength was found to be in the range of 18.7 to 21.5 MPa, and further optimization of the ratio or solvent conditions was deemed to result in further improvement of both flexibility and bonding strength.

### Examples 14 to 17

The average particle diameter of copper particles was adjusted to be less than 100 nm or to include a combination of particles less than 100 nm and particles of 2 μm, as follows, to examine the physical properties of paste compositions and films.

TABLE 5

| | | Weight ratio of | | | | |
|---|---|---|---|---|---|---|
| | | biodegradable | | | | |
| | | resin to resin | Solvent | | | Bonding |
| | Cu | for structural | and | Film | Film | strength |
| Classification | size | reinforcement | additive | formability | flexibility | [MPa] |
| Example 14 | <100 | PCL:PPC = 7:3 | NMP, | ◯ | ◯ | 6.8/8.4/ |
| | nm | | caproic | | | 18.2 |
| | | | acid | | | |
| Example 15 | <100 | PCL:PPC = 7:3 | NMP, | ◯ | ◯ | 8.1/11.5/ |
| | nm + 2 | | caproic | | | 28.2 |
| | μm | | acid | | | |
| Example 16 | <100 | PBAT:PPC = 7:3 | NMP, | ◯ | ◯ | 13.8/15.4/ |
| | nm | | caprylic | | | 18.2 |
| | | | acid | | | |
| Example 17 | <100 | PBAT:PPC = 7:3 | NMP, | ◯ | ◯ | 18.1/15.5/ |
| | nm + 2 | | caprylic | | | 27.2 |
| | μm | | acid | | | |

As shown in Table 5, when sintered by the combination of small copper particles of less than 100 nm (<100 nm) and large copper particles, the bonding strength is deemed to be improved by increasing the interparticle binding strength. Using small copper particles of less than 100 nm alone typically resulted in low bonding strength, which is deemed to be attributable to insufficient sintering due to the spacing between the copper particles.

In addition, when adding caproic acid, the oxidation inhibition effect of copper particles is high due to the short carbon chain, and uniformity is deemed to be obtainable during film formation. In the meantime, caprylic acid, due to having a relatively long carbon chain and strong hydrophobicity, is expected to improve the moisture resistance and chemical stability of the film.

### Comparative Examples 7 to 15

The physical properties of paste compositions and films were examined when the total weight was the same as that in the foregoing examples and comparative examples, but only a biodegradable resin was used without a resin for structural reinforcement.

TABLE 6

| | | | Solvent | | | Bonding |
|---|---|---|---|---|---|---|
| | Cu | Biodegradable | and | Film | Film | strength |
| Classification | size | resin | additive | formability | flexibility | [MPa] |
| Comparative | About | PCL | NMP, | X | X | — |
| Example 7 | 2 μm | | caprylic | | | |
| | | | acid | | | |
| Comparative | About | PCL | DMF, | X | X | — |
| Example 8 | 2 μm | | caprylic | | | |
| | | | acid | | | |
| Comparative | About | PCL | DMC, | X | X | — |
| Example 9 | 2 μm | | caprylic | | | |
| | | | acid | | | |
| Comparative | About | PCL | NMP/DMF, | X | X | — |
| Example 10 | 2 μm | | caprylic | | | |
| | | | acid | | | |
| Comparative | About | PCL | NMP/GBL, | X | X | — |
| Example 11 | 2 μm | | caprylic | | | |
| | | | acid | | | |
| Comparative | About | PBAT | NMP, | X | X | — |
| Example 12 | 2 μm | | caprylic | | | |
| | | | acid | | | |
| Comparative | About | PBAT | α-Terpineol, | X | X | — |
| Example 13 | 2 μm | | caprylic | | | |
| | | | acid | | | |
| Comparative | <100 | PBAT | NMP, | X | X | — |
| Example 14 | nm | | caprylic | | | |
| | | | acid | | | |
| Comparative | <100 | PBAT | NMP, | X | X | — |
| Example 15 | nm + 2 | | caprylic | | | |
| | μm | | acid | | | |

As shown in Table 6, the films of Comparative Examples 7 to 15 failed to obtain formability and flexibility, regardless of the combination of the solvent and the additive. Accordingly, it is confirmed that the combination of the biodegradable resin with the resin for structural reinforcement is indispensable, and that optimization of the solvent must also be accompanied.

While the present disclosure has been described with reference to the above specific details and limited embodiments provided to help general understanding of the present disclosure, the present disclosure is not limited to the above embodiments. Furthermore, those skilled in the art to which the present disclosure pertains will appreciate that various modifications and variations are possible from the above descriptions.

Therefore, it should be noted that the idea of the present disclosure is not limited to the examples described above, and not only the appended claims but also all equivalents and modifications thereof fall within the scope of the idea of the present disclosure.

What is claimed is:

1. A copper film paste composition comprising:
copper particles;
a biodegradable resin;
a resin for structural reinforcement;
a solvent; and
an additive.

2. The composition of claim 1, wherein the biodegradable resin comprises one or more selected from the group consisting of polycaprolactone (PCL), polybutylene adipate-co-terephthalate (PBAT), polybutylene succinate (PBS), polybutylene succinate adipate terephthalate (PBSAT), and polymethyl adipate terephthalate (PMAT).

3. The composition of claim 1, wherein the biodegradable resin has a glass transition temperature (T_{g}) of room temperature or lower.

4. The composition of claim 1, wherein the resin for structural reinforcement comprises one or more selected from the group consisting of polycarbonate (PC), polypropylene carbonate (PPC), polymethyl methacrylate (PMMA), polyethylene terephthalate (PET), polyamide (PA), polybutylene terephthalate (PBT), polysulfone (PSU), and polyphenylene sulfide (PPS).

5. The composition of claim 1, wherein the solvent comprises one or more selected from the group consisting of dimethyl succinate, dimethyl adipate, dimethyl carbonate (DMC), diethyl carbonate, dimethyl glutarate, ethylene glycol diacetate, propylene carbonate, ethylene carbonate, 2-methoxyethanol carbonate, γ-butyrolactone (GBL), dimethylformamide (DME), N-methylpyrrolidone (NMP), 2-pyrrolidone, and octanediol.

6. The composition of claim 1, wherein the composition comprises one or more reducing agents selected from the group consisting of propionic acid, caproic acid, caprylic acid, glutaric acid, glutamic acid, citric acid, succinic acid, adipic acid, phthalic acid, fumaric acid, malonic acid, stearic acid, maleic acid, mercaptopropionic acid, and γ-aminobutyric acid, as the additive.

7. The composition of claim 1, wherein the composition comprises one or more surfactants selected from the group consisting of triethanolamine (TEA), diethanolamine, monoethanolamine, cocamide diethanolamine (cocamide DEA), TEA-lauryl sulfate, cocamidopropyl betaine, and lauryl glucoside, as the additive.

8. The composition of claim 1, wherein the composition comprises one or more film-forming additives selected from the group consisting of ethyl cellulose (EC), hydroxypropyl methylcellulose, hydroxyethyl cellulose, methylcellulose, polyvinyl alcohol, polyurethane, polyacrylic acid, polylactic acid, and acetyl cellulose, as the additive.

9. A flexible copper film formed from the composition of claim 1.

10. The film of claim 9, wherein the film has a bonding strength of 15 MPa or higher.
